(19) United States
(12) Patent Application Publication
(10) Pub. No.: US 2018/0081596 A1
(43) Pub. Date: Mar. 22, 2018

(54) DATA PROCESSING APPARATUS AND DATA PROCESSING METHOD

(71) Applicant: Kabushiki Kaisha Toshiba, Minato-ku (JP)

(72) Inventors: Takuya MATSUO, Kawasaki (JP); Takashi Watanabe, Yokohama (JP); Atsushi Matsumura, Yokohama (JP)

(73) Assignee: Kabushiki Kaisha Toshiba, Minato-ku (JP)

(21) Appl. No.: 15/443,133

(22) Filed: Feb. 27, 2017

(30) Foreign Application Priority Data
Sep. 16, 2016 (JP) 2016-182090

(51) Int. Cl. G06F 3/06

(52) U.S. Cl. CPC G06F 3/0661; G06F 3/0619; G06F 3/0673; G06F 3/0608; G06F 3/0613

(57) ABSTRACT

According to an embodiment, a data processing apparatus includes a divider, a hash calculator, a hash memory, an access controller, and a compressor. The divider is configured to divide input data into blocks. The hash calculator is configured to calculate hash values from the respective blocks. The hash memory is configured to store pieces of first data that are based on the respective blocks. The access controller is configured to access the hash memory by using the hash values, read one or some of the pieces of first data, each stored at an address indicated by each hash value, from the hash memory, and write, at the addresses indicated by the hash values, pieces of first data that are determined based on the respective blocks. The compressor is configured to compress the input data into compressed data based on the input data and the read pieces of first data.

### CROSS-REFERENCE TO RELATED APPLICATIONS

This application is based upon and claims the benefit of priority from Japanese Patent Application No. 2016-182090, filed on Sep. 16, 2016; the entire contents of which are incorporated herein by reference.

### FIELD

Embodiments described herein relate generally to a data processing apparatus and a data processing method.

### BACKGROUND

As a lossless compression method for digital data, there is known a dictionary coder which compares compression target data and data held in a dictionary against each other, and which, in a case of data match, reduces the amount of data by using the position of matching data in the dictionary, the match length, and the like.

However, with the conventional technique, it is difficult to increase the throughput without reducing data compression efficiency.

### BRIEF DESCRIPTION OF THE DRAWINGS

FIG. 1 is a diagram illustrating an example configuration of a data processing apparatus according to a first embodiment;

FIG. 2A is a diagram illustrating example 1 of division of input data according to the first embodiment;

FIG. 2B is a diagram illustrating example 2 of division of input data according to the first embodiment;

FIG. 3 is a diagram for describing an example of a memory structure according to the first embodiment;

FIG. 4 is a diagram for describing an example of an access method according to the first embodiment;

FIG. 5 is a diagram illustrating an example of a dictionary memory according to the first embodiment;

FIG. 6 is a diagram illustrating an example configuration of a data processing apparatus according to a second embodiment;

FIG. 7A is a diagram for describing an example of a memory structure according to the second embodiment;

FIG. 7B is a diagram for describing an example of an access method according to the second embodiment;

FIG. 8 is a diagram illustrating an example configuration of a data processing apparatus according to a third embodiment; and

FIG. 9 is a diagram for describing an example of a process by a decompressor according to the third embodiment.

### DETAILED DESCRIPTION

According to an embodiment, a data processing apparatus includes a divider, a hash calculator, at least one hash memory, an access controller, and a compressor. The divider is configured to divide input data into a plurality of blocks. The hash calculator is configured to calculate hash values from the respective blocks. The at least one hash memory is configured to store pieces of first data that are based on the respective blocks. The access controller is configured to access the at least one hash memory by using the hash values, read one or some of the pieces of first data, each stored at an address indicated by each hash value, from the at least one hash memory, and write, at the addresses indicated by the hash values, pieces of first data that are determined based on the respective blocks. The compressor is configured to compress the input data into compressed data based on the input data and the read one or some of the pieces of first data.

Hereinafter, embodiments of a data processing apparatus and a data processing method will be described in detail with reference to the appended drawings.

### First Embodiment

First, a configuration of a data processing apparatus according to a first embodiment will be described.

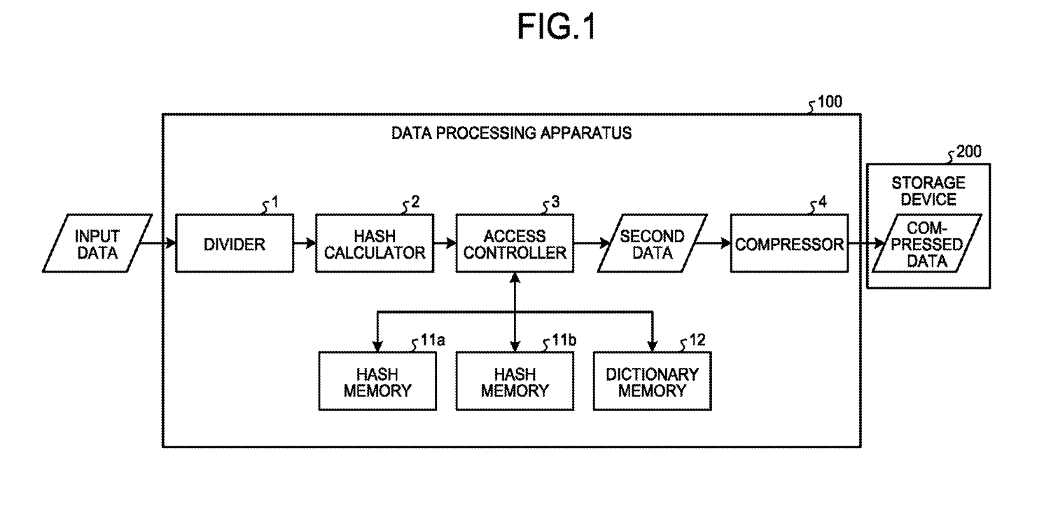

Configuration of Data Processing Apparatus FIG. 1 is a diagram illustrating an example configuration of a data processing apparatus 100 according to the first embodiment. The data processing apparatus 100 according to the first embodiment includes a divider 1, a hash calculator 2, an access controller 3, a compressor 4, a hash memory 11a, a hash memory 11b, and a dictionary memory 12. The divider 1, the hash calculator 2, the access controller 3, and the compressor 4 are realized by hardware, such as integrated circuits (IC), for example.

In the following, the hash memory 11a and the hash memory 11b will be simply referred to as the hash memory(ies) 11 when there is no need to distinguish between the two.

The divider 1 divides input data into a plurality of blocks. Any method may be used to divide the input data into a plurality of blocks.

Example Division Method

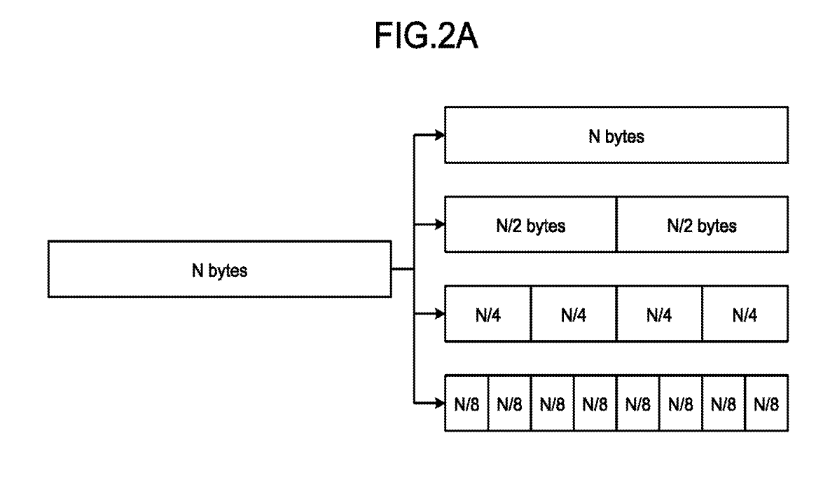

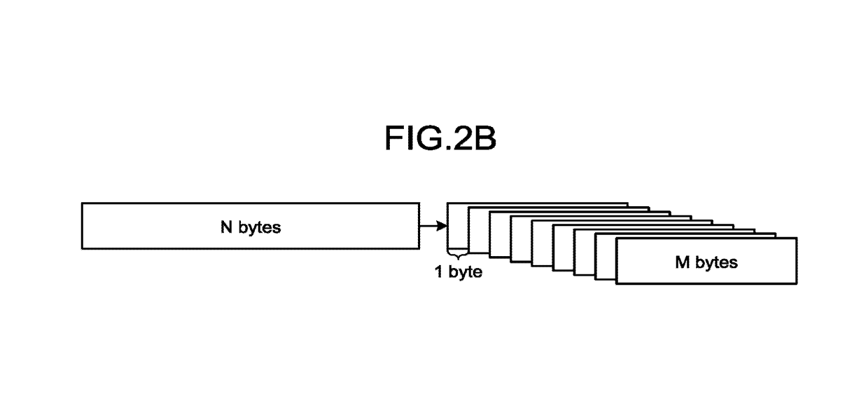

FIG. 2A is a diagram illustrating example 1 of division of input data according to the first embodiment. The example 1 of division in FIG. 2A illustrates a case where N-byte input data is divided into a plurality of non-overlapping blocks. For example, the divider 1 may divide the N-byte input data into two blocks of N/2 bytes. Also, the divider 1 may divide the N-byte input data into four blocks of N/4 bytes, for example. Moreover, the divider 1 may divide the N-byte input data into eight blocks of N/8 bytes, for example. Additionally, the divider 1 may set the number of division to one, and output the N-byte input data as it is.

FIG. 2B is a diagram illustrating example 2 of division of input data according to the first embodiment. The example 2 of division in FIG. 2B illustrates a case where the N-byte input data is divided into a plurality of overlapping blocks. For example, the divider 1 may divide the N-byte input data into blocks of M bytes (M<N) while shifting the bytes one by one from the beginning.

Referring back to FIG. 1, the divider 1 inputs the blocks to the hash calculator 2.

When a block is received from the divider 1, the hash calculator 2 calculates a hash value of the block. Any method may be used to calculate the hash value. For example, the hash calculator 2 may take one byte at the beginning of the block as the hash value. Also, the hash calculator 2 may take the number of ones or zeros in the block, which is represented by a bit sequence, as the hash value, for example. Moreover, the hash calculator 2 may calculate the hash value by using other different hash functions, for example.

The hash calculator 2 inputs the hash value of each block to the access controller 3.

When the hash value of each block is received from the hash calculator 2, the access controller 3 accesses the hash memory 11a, the hash memory 11b, and the dictionary memory 12. Before describing operation of the access controller 3, an example of a memory structure according to the first embodiment will be described.

Example of Memory Structure

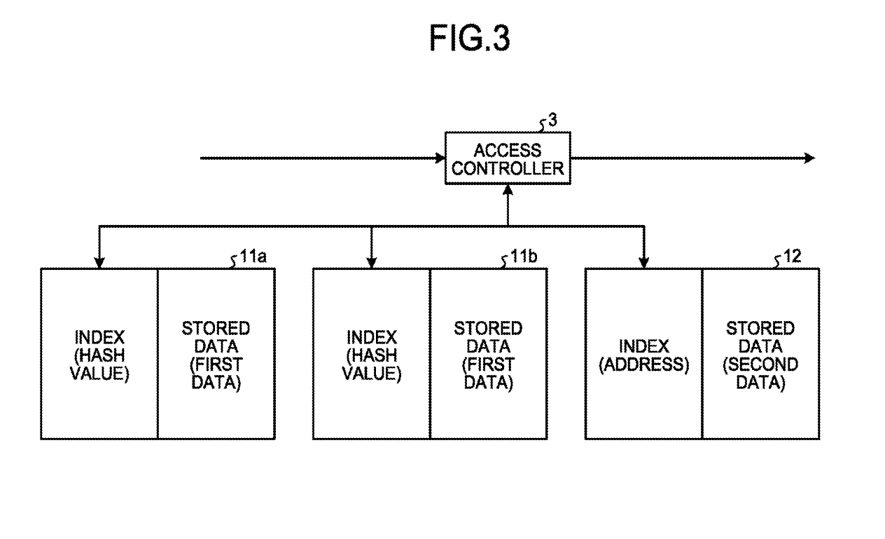

FIG. 3 is a diagram for describing an example of a memory structure according to the first embodiment. The data processing apparatus 100 according to the first embodiment includes two hash memories 11a and 11b, and one dictionary memory 12. Additionally, the number of hash memories 11 is arbitrary. The number of dictionary memories 12 is also arbitrary.

The index for the hash memory 11 is a hash value. Moreover, stored data in the hash memory 11 is first data (intermediate data), which is based on a block. The first data, which is based on a block, is arbitrary data that is specified by the block. For example, the first data, which is based on a block, is an address in the dictionary memory 12 where the block is stored.

In the description of the first embodiment, a case where the first data, which is based on a block, is the address of the block that is stored in the dictionary memory 12 will be described.

The dictionary memory 12 stores second data. The second data is two continuous blocks, for example. The second data is used as dictionary data in a compression process by the compressor 4.

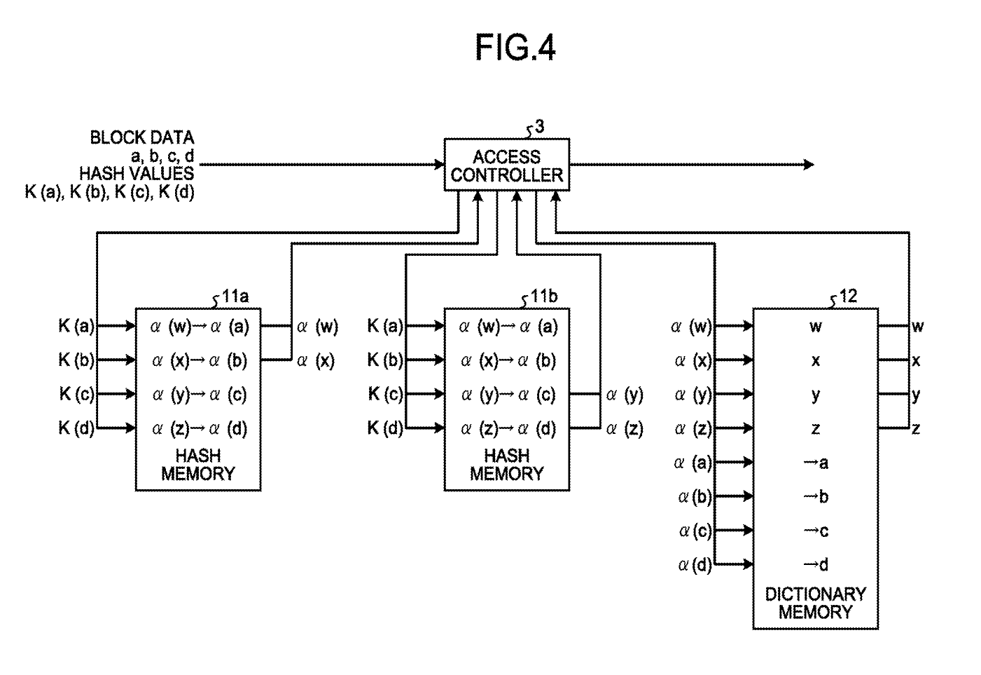

FIG. 4 is a diagram for describing an example of an access method according to the first embodiment. First, signs in FIG. 4 will be described. K(X) is the hash value of a block X. Also, a(X) is the address, in the dictionary memory 12, where the block X is stored.

First, the access controller 3 receives, from the hash calculator 2, a hash value K(a) of a block a, a hash value K(b) of a block b, a hash value K(c) of a block c, and a hash value K(d) of a block d. That is, in the example in FIG. 4, a case is described where input data is divided into four blocks by the divider 1.

Next, the access controller 3 accesses the hash memory 11a with the hash values K(a), K(b), K(c), and K(d) as indices. Then, the access controller 3 reads one or some of the pieces of first data stored at the addresses, in the hash memory 11a, indicated by the hash values, and then, writes, at the corresponding address, first data which is based on the block for which the corresponding hash value has been calculated.

Specifically, in the example in FIG. 4, the access controller 3 reads α(w) stored at the address, in the hash memory 11a, indicated by the hash value K(a), and then, writes α(a) at the address. That is, α(w) which is stored at the address indicated by K(a) is updated to α(a) after α(w) is read out.

Also, in the example in FIG. 4, the access controller 3 reads α(x) stored at the address, in the hash memory 11a, indicated by the hash value K(b), and then, writes α(b) at the address. That is, α(x) which is stored at the address indicated by K(b) is updated to α(b) after α(x) is read out.

Also, in the example in FIG. 4, the access controller 3 writes α(c) at the address, in the hash memory 11a, indicated by the hash value K(c). That is, α(y) which is stored at the address indicated by K(c) is updated to α(c) without being read out.

Moreover, in the example in FIG. 4, the access controller 3 writes α(d) at the address, in the hash memory 11a, indicated by the hash value K(d). That is, α(z) which is stored at the address indicated by K(d) is updated to α(d) without being read out.

On the other hand, in the example in FIG. 4, reading and update of the hash memory 11b are performed in the following manner.

The access controller 3 writes α(a) at the address, in the hash memory 11b, indicated by the hash value K(a). That is, α(w) which is stored at the address indicated by K(a) is updated to α(a) without being read out.

Furthermore, the access controller 3 writes α(b) at the address, in the hash memory 11b, indicated by the hash value K(b). That is, α(x) which is stored at the address indicated by K(b) is updated to α(b) without being read out.

Also, the access controller 3 reads α(y) stored at the address, in the hash memory 11b, indicated by the hash value K(c), and then, writes α(c) at the address. That is, α(y) which is stored at the address indicated by K(c) is updated to α(c) after α(y) is read out.

Also, the access controller 3 reads α(z) stored at the address, in the hash memory 11b, indicated by the hash value K(d), and then, writes α(d) at the address. That is, α(z) which is stored at the address indicated by K(d) is updated to α(d) after α(z) is read out.

That is, the number of times of reading of the hash memory 11a is two, and the number of the number of times of update (writing) of the hash memory 11a is four.

Also, that is, the number of times of reading of the hash memory 11b is two, and the number of the number of times of update (writing) of the hash memory 11b is four. The access controller 3 accesses the dictionary memory 12 by α(w) and α(x) read out from the hash memory 11a and α(y) and α(z) read out from the hash memory 11b. Then, the access controller 3 reads second data from the dictionary memory 12.

Furthermore, the access controller 3 writes in the dictionary memory 12, as second data, input data which is being processed (a plurality of pieces of block data obtained by the divider 1). Additionally, the address in the dictionary memory 12 where the input data which is being processed is to be stored has to be in correspondence with the address used for storing the data as the first data at the time of update of the hash memory 11. For example, the dictionary memory 12 may be updated by a method of shifting the address position k by k. For example, k is one.

In the case of k=1, the block a which is to be stored as the second data is written at an access position, in the dictionary memory, indicated by the address α(a), for example. At this time, the address is α(a)=α(prev)+1. Additionally, α(prev) is the access position of last writing in the dictionary memory 12. That is, in this case, it is the access position for input data processing of which has been completed immediately before.

Also, in the case of sequentially writing the block b, the block c, and the block d after the block a, the addresses will be α(b)=α(a)+1, α(c)=α(b)+1, and α(d)=α(c)+1.

As described above, the number of times of reading of the hash memory 11a is two, and the number of times of writing in the hash memory 11a is four, and thus, the number of times of access to the hash memory 11a is six in total. That is, the number of times the access controller 3 reads the first data from the hash memory 11a and the number of times the access controller 3 writes the first data in the hash memory 11a are different. The number of times of writing in the hash memory 11a by the access controller 3 is four, and thus, the update frequency is maintained and the search performance in the dictionary memory 12 is not reduced.

Likewise, the number of times of reading of the hash memory 11b is two, and the number of times of writing in the hash memory 11b is four, and thus, the number of times of access to the hash memory 11b is six in total. That is, the number of times the access controller 3 reads the first data from the hash memory 11b and the number of times the access controller 3 writes the first data in the hash memory 11b are different. The number of times of writing in the hash memory 11b by the access controller 3 is four, and thus, the update frequency is maintained and the search performance in the dictionary memory 12 is not reduced.

Furthermore, by causing the hash memories 11a and 11b to operate in parallel, the throughput may be increased compared to a conventional access method of performing reading four times and writing four times with respect to one hash memory, for example.

Next, an example of the dictionary memory 12 according to the first embodiment will be described.

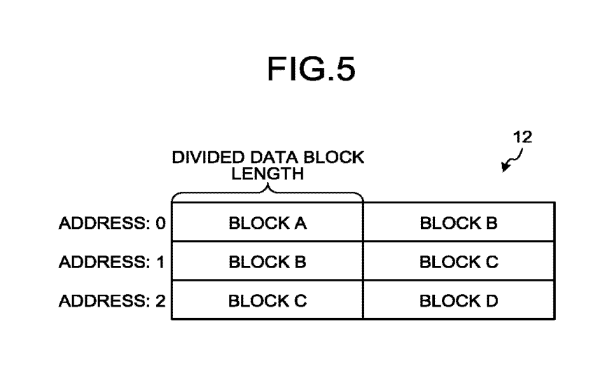

FIG. 5 is a diagram illustrating an example of the dictionary memory 12 according to the first embodiment. The access controller 3 reads, in one access, second data of a data length that is longer than the data length of a block obtained by the divider 1. In the example in FIG. 5, a case is illustrated where two continuous blocks are stored, as the second data, at one address in the dictionary memory 12. That is, in the example in FIG. 5, the data length of the second data is two times the data length of a block. Additionally, the data length of the second data does not have to be two times the data length of a block, and may be longer.

In the example in FIG. 5, a block A and a block B following the block A are stored at an address α(A)=0 where the block A is to be stored. Also, the block B and a block C following the block B are stored at an address α(B)=1 where the block B is to be stored. Moreover, the block C and a block D following the block C are stored at an address α(C)=2 where the block C is to be stored.

Accordingly, compared to the conventional method of storing one block at one address, longer data may be acquired by one access. Therefore, the access controller 3 may read, from the dictionary memory 12, second data of a longer data length than the data length of a block obtained by the divider 1 in less accesses compared to the conventional method. The dictionary memory 12 illustrated in FIG. 5 enables the compression efficiency to be increased without reducing the throughput. Additionally, the second data may be input data which is being processed and data following such input data, or may be input data which is being processed and some kind of data which is estimated from such input data.

Additionally, the address indicating the access position for second data stored in the dictionary memory 12 may be separated into an address indicating the top portion of the second data and an address indicating the position of data included in the second data.

Referring back to FIG. 1, the access controller 3 inputs second data to the compressor 4. For example, in the case where input data is divided into four blocks by the divider 1, the access controller 3 inputs four pieces of second data to the compressor 4. Also, for example, division of input data into four blocks and eight blocks may be simultaneously performed by the divider 1, and the access controller 3 may input second data according to several division patterns to the compressor 4.

When second data (for example, a plurality of continuous blocks) is received from the access controller 3, the compressor 4 compresses the input data into compressed data based on the second data and the input data. For example, the compressor 4 compresses the input data into compressed data by comparing the input data and the second data against each other and reducing the amount of data of matching parts.

A storage device 200 stores the compressed data compressed by the compressor 4. Additionally, a system may be configured by the data processing apparatus 100 and the storage device 200.

As described above, with the data processing apparatus 100 according to the first embodiment, the number of times the access controller 3 reads first data stored in the hash memory 11a and the number of times the access controller 3 updates the first data stored in the hash memory 11a are different. Likewise, the number of times the access controller 3 reads first data stored in the hash memory 11b and the number of times the access controller 3 updates the first data stored in the hash memory 11b are different. The hash memory 11a and the hash memory 11b operate in parallel. Moreover, the access controller 3 reads, from the dictionary memory 12, second data of a longer data length than the data length of a block in one access. Also, the access controller 3 writes, in the dictionary memory 12, second data of a longer data length than the data length of a block in one access.

Therefore, with the data processing apparatus 100 according to the first embodiment, by suppressing reduction in the search performance in the dictionary memory 12 due to parallel processing of the hash memories 11, reduction in the compression efficiency may be suppressed, and also, high throughput may be expected due to parallel processing of the hash memories 11. Also, because second data of a long data length may be acquired from the dictionary memory 12 while suppressing an increase in the number of accesses to the dictionary memory 12, the compression efficiency may be increased.

### Second Embodiment

Next, a second embodiment will be described. In the description of the second embodiment, similarities to the first embodiment are omitted, and differences from the first embodiment will be described.

Configuration of Data Processing Apparatus

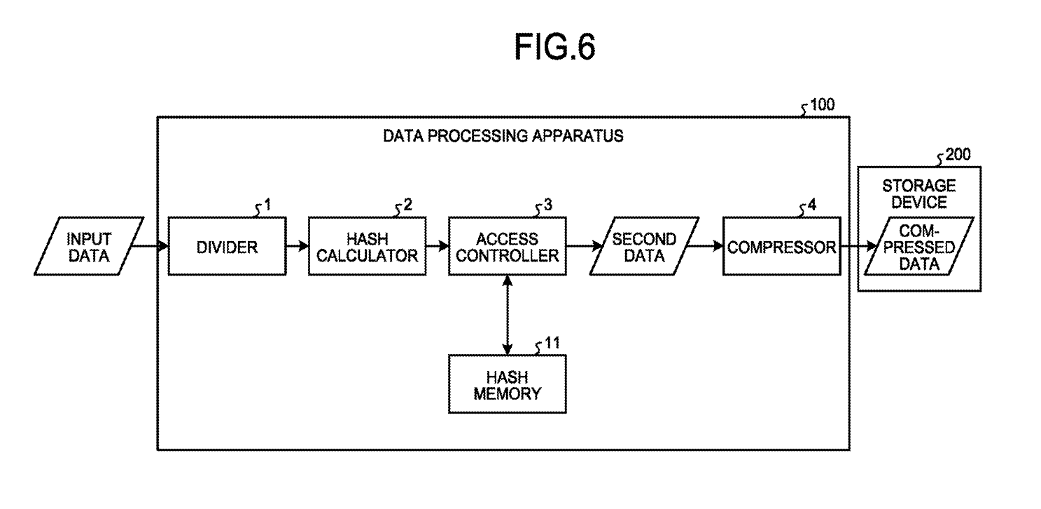

FIG. 6 is a diagram illustrating an example configuration of a data processing apparatus 100 according to the second embodiment. The data processing apparatus 100 according to the second embodiment includes a divider 1, a hash calculator 2, an access controller 3, a compressor 4, and a hash memory 11. That is, the data processing apparatus 100 according to the second embodiment is different from the data processing apparatus 100 according to the first embodiment with respect to a memory structure. The number of hash memories 11 is arbitrary.

Description of the divider 1, the hash calculator 2, and the compressor 4 according to the second embodiment is the same as the description in the first embodiment, and is omitted. In the description in the second embodiment, the access controller 3 and the hash memory 11 will be described.

First, an example of a memory structure according to the second embodiment will be described.

Example of Memory Structure

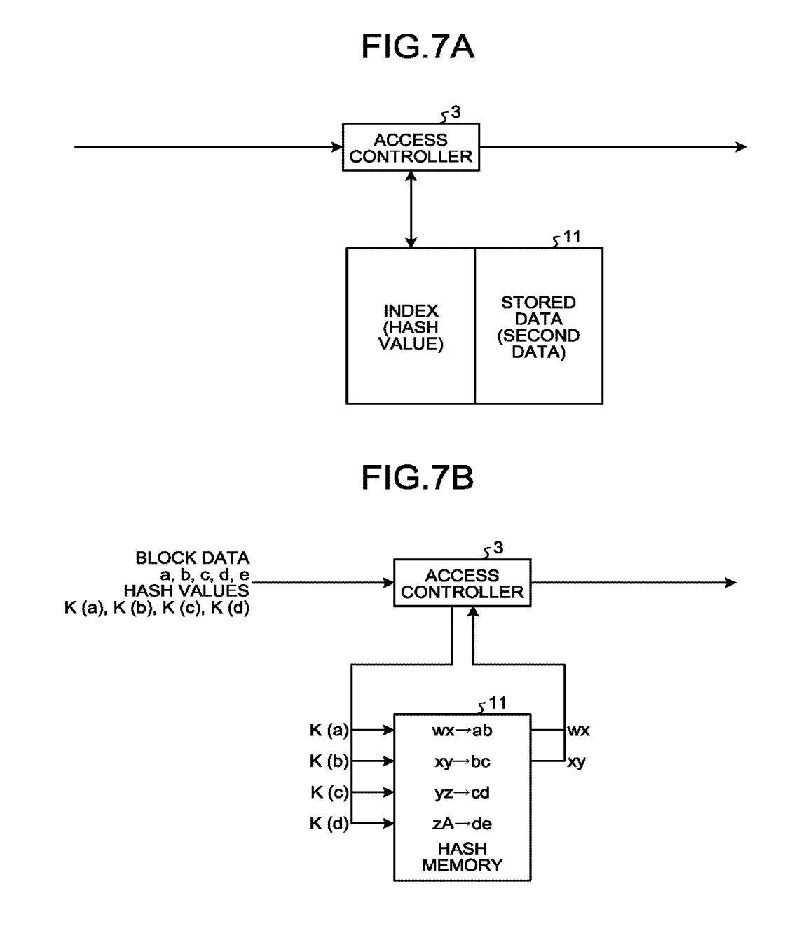

FIG. 7A is a diagram for describing an example of a memory structure according to the second embodiment. The data processing apparatus 100 according to the second embodiment includes a hash memory 11.

The index for the hash memory 11 is a hash value. Moreover, stored data in the hash memory 11 is the second data described above. The second data according to the second embodiment is the same as that of the first embodiment, and description thereof is omitted. The second data which is stored in the dictionary memory 12 in the first embodiment is stored in the hash memory 11 in the second embodiment.

Additionally, the address indicating the access position for second data stored in the hash memory 11 may be separated into an address indicating the top portion of the second data and an address indicating the position of data included in the second data.

The access controller 3 performs reading and update of second data stored in the hash memory 11. When the hash value of each block is received from the hash calculator 2, the access controller 3 accesses the hash memory 11 with the hash value as the index. Then, the access controller 3 reads one or some of the pieces of second data without reading all the second data accessed.

FIG. 7B is a diagram for describing an example of an access method according to the second embodiment. In FIG. 7B, the block data e is following the block data d. Similarly, the second data A is following the second data z.

Specifically, in the case where the hash memory 11 is accessed by hash values K(a), K(b), K(c), and K(d), the access controller 3 reads pieces of second data which are stored at the hash values K(a) and K(b), for example.

Next, the access controller 3 updates the hash memory 11 by writing input data (a plurality of pieces of block data), corresponding to the hash values, which is being processed. Specifically, in the case where the hash memory 11 is accessed by the hash values K(a), K(b), K(c), and K(d), the access controller 3 writes, as the second data, a block a and a block b at an address indicated by K(a), writes, as the second data, the block b and a block c at an address indicated by K(b), writes, as the second data, the block c and a block d at an address indicated by K(c), and writes, as the second data, the block d and a block e at an address indicated by K(d).

Lastly, the access controller 3 inputs the one or some of the pieces of second data read from the hash memory 11 to the compressor 4.

As described above, according to the data processing apparatus 100 of the second embodiment, the same effect as that of the data processing apparatus 100 according to the first embodiment is achieved.

### Third Embodiment

Next, a third embodiment will be described. In the description of the third embodiment, similarities to the first embodiment are omitted, and differences from the first embodiment will be described.

Configuration of Data Processing Apparatus

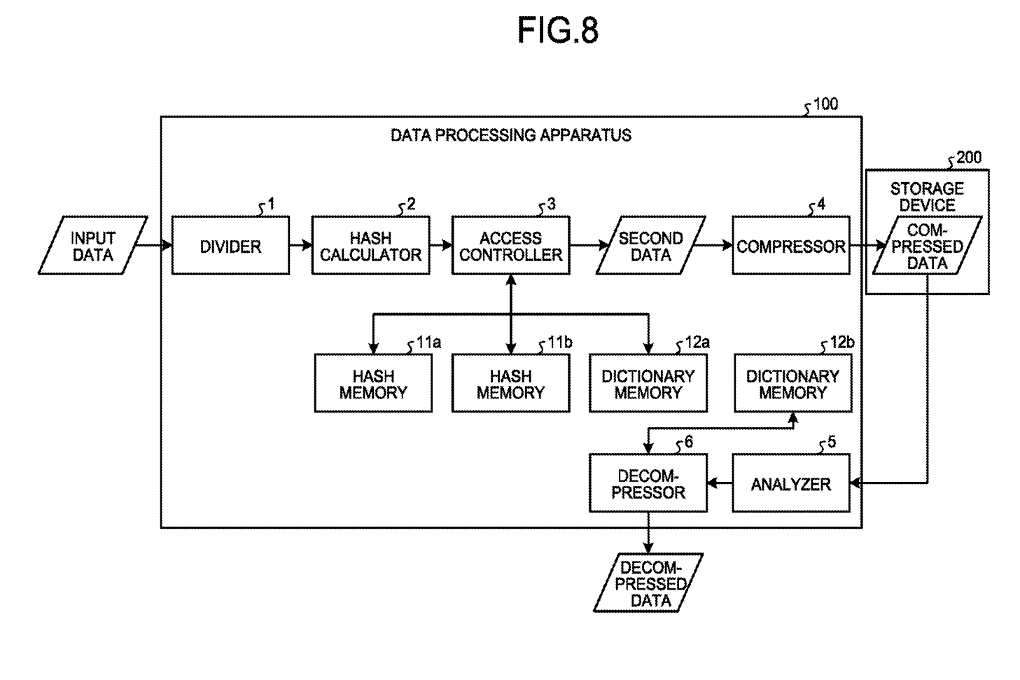

FIG. 8 is a diagram illustrating an example configuration of a data processing apparatus 100 according to the third embodiment. The data processing apparatus 100 according to the third embodiment includes a divider 1, a hash calculator 2, an access controller 3, a compressor 4, an analyzer 5, a decompressor 6, a hash memory 11a, a hash memory 11b, a dictionary memory 12a, and a dictionary memory 12b. That is, the data processing apparatus 100 according to the third embodiment is the data processing apparatus 100 according to the first embodiment to which the analyzer 5, the decompressor 6, and the dictionary memory 12b are further added. The divider 1, the hash calculator 2, the access controller 3, the compressor 4, the analyzer 5, and the decompressor 6 are realized by hardware, such as ICs, for example. The dictionary memory 12b is used for decompressing of compressed data. The memory structure and stored data of the dictionary memory 12b are the same as the memory structure and stored data of the dictionary memory 12a.

Description of the divider 1, the hash calculator 2, the access controller 3, the compressor 4, the hash memory 11a, the hash memory 11b, and the dictionary memory 12a according to the third embodiment is the same as the description in the first embodiment, and is omitted. In the description in the third embodiment, the analyzer 5, the decompressor 6, and the dictionary memory 12b will be described.

The analyzer 5 acquires analysis information indicating an analysis result by analyzing compressed data. The analysis information includes match information of compressed data and second data (dictionary data), an address in the dictionary memory 12b, and the like, for example. The match information includes information indicating whether data included in compressed data and dictionary data stored in the dictionary memory 12b match each other or not, and information indicating the matching (or non-matching) data length, for example. Also, an address in the dictionary memory 12b indicates an access position for the second data matching the data included in the compressed data. In the case where input data is compressed by variable length coding or coding that uses some kind of prediction method, such as coding that uses a difference value to immediately preceding data, the analyzer 5 also acquires, as the analysis information, information that is necessary to decompress (decode) the compressed data. The analyzer 5 inputs the analysis information to the decompressor 6.

When the analysis information is received from the analyzer 5, the decompressor 6 generates decompressed data from the compressed data based on the analysis information. Additionally, the decompressed data is the same as the input data which has been input to the divider 1.

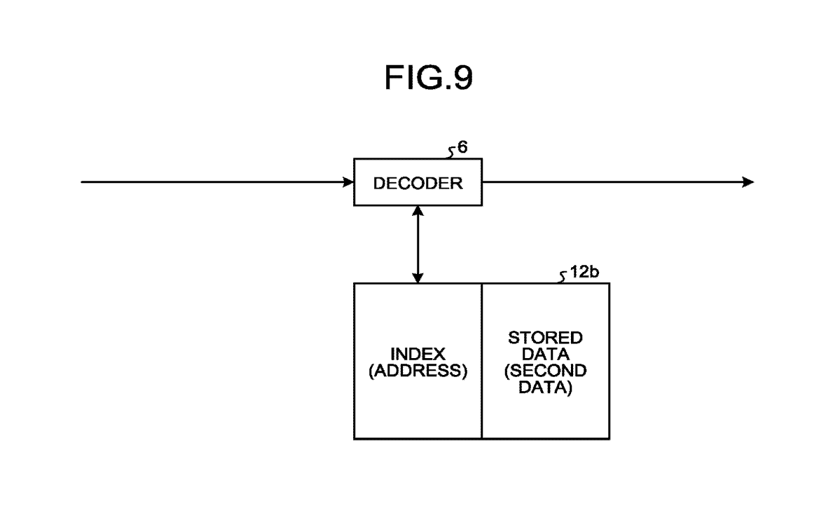

FIG. 9 is a diagram for describing an example of a process by the decompressor 6 according to the third embodiment. The decompressor 6 decompresses compressed data into decompressed data while performing reading and update of second data which is stored in the dictionary memory 12b. That is, in a decompressing process (decoding process) by the decompressor 6, a reverse process of the compression process performed by the compressor 4 on input data is performed. Specifically, the decompressor 6 acquires second data from the address in the dictionary memory 12b included in analysis information, and decompresses compressed data by using the second data. Additionally, in the case of non-match to the dictionary or in the case of compression by another coding method, or in the case of match to the dictionary and use of another coding method, the decompressor 6 performs the decompressing process based on necessary information. Also, the decompressor 6 updates the dictionary memory 12b by an already decompressed block. When the decompressing process of the compressed data is completed, the decompressor 6 outputs the decompressed data.

Here, the second data which is stored at one address in the dictionary memory 12b is data of a longer data length than the block described above. For example, the second data has a data length two times the data length of the block. Accordingly, the number of times of accesses to the dictionary memory 12b for decompressing of the compressed data may be reduced compared to a case where one block is stored at one address, and thus, the throughput is increased. Additionally, the second data stored in the dictionary memory 12b may be a block and a following block, or may be a block and some kind of data which is estimated from the data. However, the data has to be the same as the second data which has been used in the compression process.

As described above, with the data processing apparatus 100 according to the third embodiment, the decompressor 6 acquires in one access, from the dictionary memory 12b, the second data of a data length longer than the data length of block data. Therefore, with the data processing apparatus 100 according to the third embodiment, the throughput of the decompressing process for decompressing compressed data generated by the compressor 4 may be increased.

Additionally, some kind of data according to input data may be held in advance in the hash memory 11 and the dictionary memory 12 according to the first to the third embodiments described above.

For example, with the data processing apparatus 100 according to the first embodiment, second data whose appearance frequency is statistically high may be held in advance in the dictionary memory 12, and the address in the dictionary memory 12 may be held in advance in the hash memory 11. For example, in the case where the second data includes two blocks, an address in the dictionary memory 12 is stored at an address in the hash memory 11 indicated by the hash value of a block at the beginning, the address in the dictionary memory 12 indicating an access position for second data including the corresponding block at the beginning. In this case, the hash memory 11 and the dictionary memory 12 may be, but not necessarily, updated.

For example, in the case where the hash memory 11 and the dictionary memory 12 are updated, match between data included in input data and the second data (dictionary data) may be expected even in a situation where not much time has passed from the start of the compression process when the hash memory 11 and the dictionary memory 12 are not yet sufficiently updated, thereby allowing compression of the input data.

Also, in the case where the hash memory 11 and the dictionary memory 12 are not updated, the number of times of accesses to the hash memory 11 and the dictionary memory 12 may be reduced, and thus, the throughput of the compression process may be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising:
a divider configured to divide input data into a plurality of blocks;
a hash calculator configured to calculate hash values from the respective blocks;
at least one hash memory configured to store pieces of first data that are based on the respective blocks;
an access controller configured to
access the at least one hash memory by using the hash values,
read one or some of the pieces of first data, each stored at an address indicated by each hash value, from the at least one hash memory, and
write, at the addresses indicated by the hash values, pieces of first data that are determined based on the respective blocks; and
a compressor configured to compress the input data into compressed data based on the input data and the read one or some of the pieces of first data.

2. The apparatus according to claim 1, wherein
the pieces of first data are a plurality of the blocks, and
the compressor compares the input data and the plurality of the blocks against each other and eliminates a matching part, to compress the input data into the compressed data.

3. The apparatus according to claim 1, further comprising at least one dictionary memory configured to store a plurality of the blocks at addresses, wherein
the pieces of first data are the addresses in the at least one dictionary memory where the plurality of blocks are to be stored,
the access controller accesses the dictionary memory by using the one or some of the pieces of first data, and reads the plurality of blocks, and
the compressor compares the input data and the plurality of blocks against each other and eliminates a matching part, to compress the input data into the compressed data.

4. The apparatus according to claim 1, further comprising a decompressor configured to decompress the input data from the compressed data and the pieces of first data.

5. The apparatus according to claim 1, wherein addresses indicating access positions for the pieces of first data in the at least one hash memory each include a top portions of a corresponding piece of the first data and a position of data included in the first data.

6. A data processing method comprising:
dividing input data into a plurality of blocks;
calculating hash values from the respective blocks;
storing, in at least one hash memory, pieces of first data that are based on the respective blocks;
accessing the at least one hash memory by using the hash values;
reading one or some of the pieces of first data, each stored at an address indicated by each hash value, from the at least one hash memory;
writing, at the addresses indicated by the hash values, pieces of first data that are determined based on the respective blocks; and
compressing the input data into compressed data based on the input data and the read one or some of the pieces of first data.
